(19) United States
(12) Patent Application Publication
(10) Pub. No.: US 2026/0228230 A1
(43) Pub. Date: Aug. 6, 2026

(54) METHOD FOR SEARCHING LEDGERS, SYSTEM FOR SEARCHING LEDGERS, INFORMATION PROCESSING DEVICE AND NON-TRANSITORY COMPUTER READABLE MEDIUM

(71) Applicant: NEC Corporation, Tokyo (JP)

(72) Inventors: Yasuo IIMURA, Tokyo (JP); Takuya SERA, Tokyo (JP)

(73) Assignee: NEC Corporation, Tokyo (JP)

(21) Appl. No.: 19/150,227

(22) PCT Filed: Dec. 21, 2023
(86) PCT No.: PCT/JP2023/045950

§ 371 Date: Jul. 23, 2025

(30) Foreign Application Priority Data
Feb. 2, 2023 (JP) 2023-014930

(51) Int. Cl. G06F 16/2457; G06F 16/248

(52) U.S. Cl. CPC G06F 16/24578; G06F 16/248

(57) ABSTRACT

Provided is a method for determining the degree of importance of ledgers in accordance with a query category, and changing the display order of the ledgers on the basis of the determination. Provided is a method for searching ledgers recorded in a database on the basis of document description, the method including: determining the type of each ledger; determining a category of a query that employs the description, to calculate the degree of importance of the ledgers with respect to the description; using the query to search the ledgers, by searching for the description from among sentences written in the ledgers; calculating a degree of similarity between the description employed in the query and the sentences written in the searched ledgers; and determining the display order of the ledgers from the degree of importance of each ledger and the degree of similarity of the description.

### TECHNICAL FIELD

The present disclosure relates to a method for searching ledgers, a system for searching ledgers, and an information processing device.

### BACKGROUND ART

A method for executing a search for a sentence has been developed. PTL 1 describes inputting a query and classifying the query character strings into categories. Information including category information relevant to the categories into which the query character strings are classified is extracted as a search target, and a search process is executed based on the query character strings using the extracted information as the search target.

### CITATION LIST

### Patent Literature

PTL 1: JP 2006-227823 A

### SUMMARY OF INVENTION

However, in PTL 1, it has not been considered that ledgers of importance differ by the category of the query. In addition, changing the display order of the ledgers in accordance with the degrees of importance has not been considered. Therefore, an object of the present disclosure is to provide a method for determining degrees of importance of ledgers in accordance with a category of a query and changing a display order of the ledgers based on the determination.

A method for searching ledgers of the present disclosure is a method for searching ledgers recorded in a database based on a description in a document, the method including
calculating degrees of importance of the ledgers with respect to the description by determining the type of each ledger and determining a category of a query that employs the description,
searching the ledgers using the query by searching for the description from among sentences written in the ledgers,
calculating degrees of similarity between the description employed in the query and the sentences written in the searched ledgers, and
determining a display order of the ledgers based on the degrees of importance of the ledgers and the degrees of similarity between the description and the sentences written in the ledgers.

A system for searching ledgers of the present disclosure is a system for searching ledgers recorded in a database based on a description in a document, the system including
a means for calculating degrees of importance of ledgers that calculates degrees of importance of the ledgers with respect to the description by determining the type of each ledger and determining a category of a query that employs the description,
a means for searching that searches the ledgers using the query by searching for the description from among sentences written in the ledgers,
a means for calculating degrees of similarity between a description and sentences written in ledgers that calculates degrees of similarity between the description employed in the query and the sentences written in the searched ledgers, and
a means for determining a display order of ledgers that determines a display order of the ledgers based on the degrees of importance of the ledgers and the degrees of similarity between the description and the sentences written in the ledgers.

An information processing device of the present disclosure is an information processing device for searching ledgers recorded in a database based on a description in a document, the information processing device including
a means for calculating degrees of importance of ledgers that calculates degrees of importance of the ledgers with respect to the description by determining the type of each ledger and determining a category of a query that the description,
a means for searching that searches the ledgers using the query by searching for the description from among sentences written in the ledgers,
a means for calculating degrees of similarity between a description and sentences written in ledgers that calculates degrees of similarity between the description employed in the query and the sentences written in the searched ledgers, and
a means for determining a display order of ledgers that determines a display order of the ledgers based on the degrees of importance of the ledgers and the degrees of similarity between the description and the sentences written in the ledgers.

According to the present disclosure, it is possible to provide a method for determining degrees of importance of ledgers in accordance with a category of a query and changing a display order of the ledgers based on the determination.

### BRIEF DESCRIPTION OF DRAWINGS

FIG. 1 is a schematic diagram of a method for searching ledgers according to the present disclosure.

FIG. 2 is a flowchart illustrating an outline of the method for searching ledgers according to the present disclosure.

FIG. 3 is a flowchart for determining a display order in the method for searching ledgers according to the present disclosure.

FIG. 4 is a block diagram illustrating configurations of a system for searching ledgers and an information processing device according to the present disclosure.

### EXAMPLE EMBODIMENT

### Scope of Application of Method for Searching Ledgers According to Example Embodiment

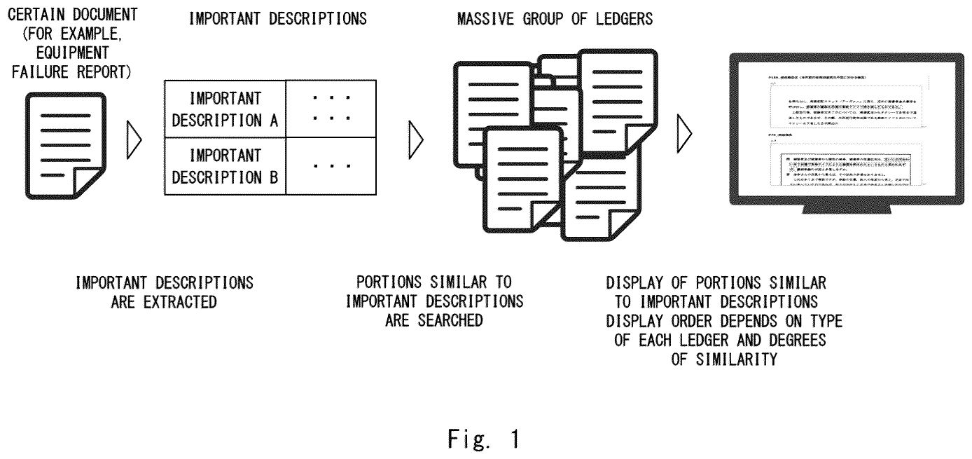

A method for searching ledgers will be described with reference to FIG. 1.

The method for searching ledgers of the present disclosure is, for example, a method for searching for an important description in a document such as an “equipment failure report” and an “estimate request form” from a massive group of ledgers recorded in a database. As illustrated in the first part from the left and the second part from the left in FIG. 1, important descriptions in a certain document are extracted. Then, as illustrated in the third part from the left in FIG. 1, portions having similar meanings to the important descriptions are quickly searched in the massive group of ledgers. In this manner, the important descriptions in the certain document are extracted, and a fuzzy search is performed on the massive group of ledgers using the important descriptions as queries.

There are a plurality of sentences having similar meanings to the query statement in each of a plurality of ledgers. However, degrees of importance of the ledgers change depending on the query. For example, in the case of an “equipment failure report”, when “cause of failure” is the query, “failure cause analysis report” or “report on results of interview with engineer” is important, and when “failure date” is the query, “record of failure reports” is important. Even when “cause of failure” is described in “record of failure reports”, “record of failure reports” is not important.

Therefore, as illustrated in the first part from the right in FIG. 1, in the method for searching ledgers of the present disclosure, the degrees of importance of the ledgers are calculated for each query, and the display order is determined. The display order of the similar portions depends on the type of each ledger and the degrees of similarity. Here, the “equipment failure report” has been described as an example, but the method for searching ledgers of the present disclosure can be applied as long as the ledgers are searched of which the degrees of importance change by other queries. A system and an information processing device of the present disclosure are for executing the above method.

### Description of Method for Searching Ledgers According to Example Embodiment

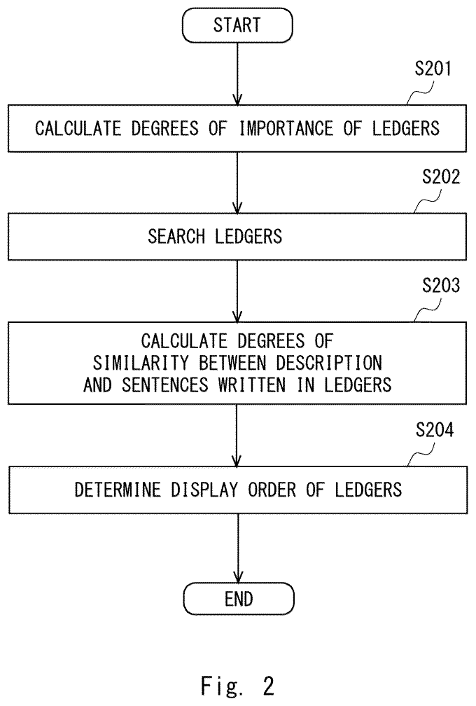

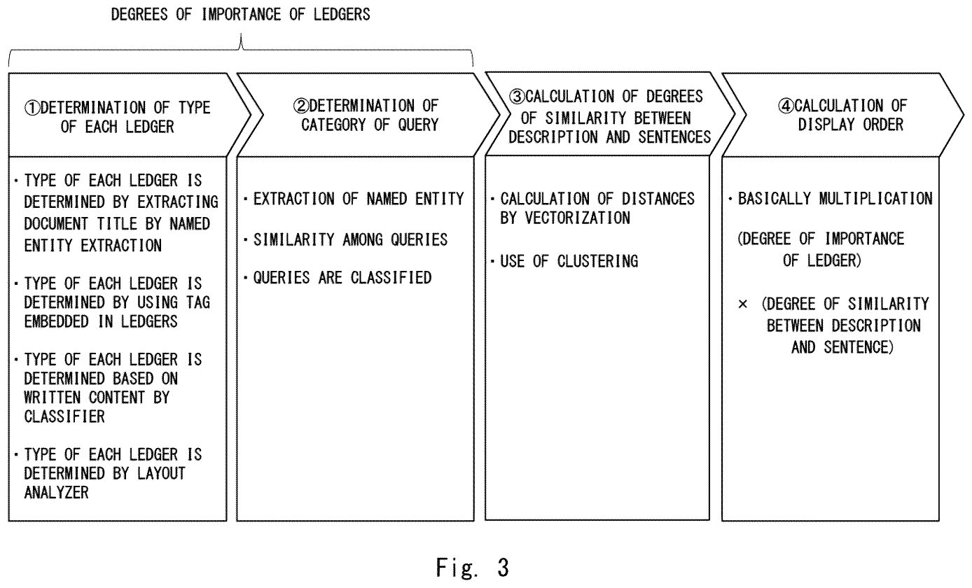

The method for searching ledgers will be described with reference to FIGS. 2 and 3.

As illustrated in FIG. 2, first, degrees of importance of ledgers are calculated (step S201). The degrees of importance of the ledgers with respect to a description in a document are calculated by determining the type of each ledger and determining a category of a query that employs the description.

The type of each ledger refers to, for example, a type of a ledger that supports a description in a certain document, such as “failure cause analysis report” or “report on results of interview with engineer”. As illustrated in FIG. 3, a first method for determining the type of each ledger is performed by extracting a document title by named entity extraction and determining the type of each ledger. The named entity refers to the text itself. For example, a text such as “failure cause analysis report” is extracted as it is from a ledger.

A second method for determining the type of each ledger is performed by determining the type of each ledger using a tag embedded in the ledger. In a database, for example, a tag related to a reporter such as an engineer, a supervisor, or a person who discovered the failure is attached to the ledger. The type of each ledger is determined using such a tag.

A third method for determining the type of each ledger is performed by determining the type of each ledger based on the written content using a classifier. The type of each ledger is determined by using a classifier that performs machine learning of a plurality of ledgers and outputs the type of each ledger by inputting selected ledgers.

A fourth method for determining the type of each ledger is performed by determining the type of each ledger using a layout analyzer. The type of each ledger is determined by using a layout analyzer that performs machine learning of layouts of a plurality of ledgers and outputs the type of each ledger by inputting selected ledgers.

These four methods for determining the type of each ledger may be performed singly or in combination. In this manner, the type of each ledger is determined.

Determining the category of the query that employs the description in the document is to classify the query as shown in FIG. 3. The classification of the query is performed by extracting a named entity in the query or extracting the named entity that has been modified using a similarity in the query and classifying the query for each named entity or named entity that has been modified. An example of the extraction of the named entity in the query is the extraction of “April 1, Reiwa 4” in the input of the failure date. An example of the extraction of the named entity in the query that has been modified using a similarity is the extraction of “April 1, 2022” obtained by converting the

Japanese calendar to the Western calendar in the input of the failure date. In this manner, it is assumed that a fuzzy search is performed. In addition, it is also possible to search for a named entity obtained by modifying a named entity such as “A did B.” to “A performed B.”.

In addition, classifying the query means classifying the query into “failure date”, “repair date”, “reporter”, “cause of failure”, and the like. The degrees of importance of the ledgers with respect to the description are calculated based on the type of each ledger and the classification of the query described above.

Next, as illustrated in FIG. 2, the ledgers are searched (step S202). The ledgers are searched in the database using the query by searching for the description in the document from among sentences written in the ledgers.

Next, degrees of similarity between the description and the sentences written in the ledgers are calculated (step S203). Degrees of similarity between the description employed in the query and the sentences written in the searched ledgers are calculated. Since a fuzzy search is performed, the description in the query does not necessarily match the sentences in the ledgers. Therefore, as illustrated in FIG. 3, the degrees of similarity between the description in the query and the sentences in the ledgers are calculated by, for example, calculating the distances by vectorizing the description in the query and the sentences in the ledgers or clustering the description in the query and the sentences in the ledgers.

Finally. as illustrated in FIG. 2, a display order of the ledgers is determined (step S204). The display order of the ledgers that have been found in the search is determined based on the degree of importance of the ledgers and the degrees of similarity between the description and the sentences written in the ledgers. As illustrated in FIG. 3, the display order of the ledgers is determined by multiplying the degree of importance of a ledger by the degree of similarity between the description and the sentence written in the ledgers.

According to the above method, it is possible to provide a method for determining degrees of importance of ledgers in accordance with a category of a query and changing a display order of the ledgers based on the determination.

### Description of System and Information Processing Device for Searching Ledgers According to Example Embodiment

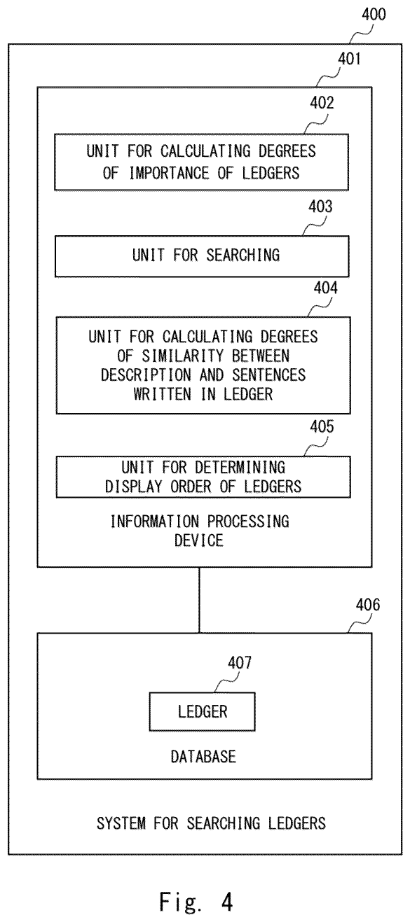

The system and the information processing device for searching ledgers will be described with reference to FIG. 4.

As illustrated in FIG. 4, a system 400 for searching ledgers includes an information processing device 401 and a database 406. The information processing device 401 for searching ledgers according to the present disclosure includes a unit 402 for calculating degrees of importance of ledgers, a unit 403 for searching, a unit 404 for calculating degrees of similarity between a description and sentences written in ledgers, and a unit 405 for determining a display order of ledgers. The database 406 stores a ledger 407.

Although not illustrated, the information processing device 401 is physically configured at least by a processor (for example, a central processing unit (CPU)) that executes a program for executing processing and a memory that stores the program. The information processing device 401 performs, by executing the program, processing in the unit 402 for calculating degrees of importance of ledgers, the unit 403 for searching, the unit 404 for calculating degrees of similarity between a description and sentences written in ledgers, and the unit 405 for determining a display order of ledgers.

The unit 402 for calculating degrees of importance of ledgers has a function of calculating the degrees of importance of ledgers with respect to a description by determining the type of each ledger and determining a category of a query that employs the description. The degrees of importance of the ledgers are calculated as described above.

The unit 403 for searching has a function of searching ledgers using the query by searching for the description from among sentences written in the ledgers. The ledgers are searched as described above.

The unit 404 for calculating degrees of similarity between a description and sentences written in ledgers has a function of calculating degrees of similarity between the description employed in the query and the sentences written in the searched ledgers. The similarities between the description and the sentences written in the ledgers are calculated as described above.

The unit 405 for determining a display order of ledgers has a function of determining a display order of the ledgers based on the degrees of importance of the ledgers and the degrees of similarity between the description and the sentences written in the ledgers. The display order of the ledgers is determined as described above.

The terms unit 402 for calculating degrees of importance of ledgers, unit 403 for searching, unit 404 for calculating degrees of similarity between a description and sentences written in ledgers, and unit 405 for determining a display order of ledgers can be replaced with a means for calculating degrees of importance of ledgers, a means for searching, a means for calculating degrees of similarity between a description and sentences written in ledgers, and a means for determining a display order of ledgers, respectively.

The database 406 includes a large-capacity storage device. The storage device is preferably a hard disk or a solid state drive (SSD). The database 406 may be any database. For example, the database 406 may be a “hierarchical type”, a “network type”, or a “relational type”.

A massive amount of the ledgers 407 is stored in the storage device of the database. The ledgers 407 are particularly preferably tagged with meta-information or the like.

Here, the information processing device 401 and the database 406 are described separately, but the information processing device 401 and the database 406 may be integrated by recording the ledger 407 in the memory of the information processing device. The information processing device 401 may distribute some or all functions in a cloud server and cause the cloud server to execute the functions.

In addition, a part or all of the processing in the information processing device 401 described above can be enabled as a computer program. Such a program can be stored and supplied to the computer using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (e.g., a magneto-optical disc), a CD-read only memory (ROM), a CD-R, a CD-R/W, and a semiconductor memory (e.g., a mask ROM, a programmable ROM (PROM), an erasable PROM (EPROM), a flash ROM, or a random access memory (RAM)). The program may be supplied to the computer using various types of transitory computer-readable media. Examples of the transitory computer-readable media include electrical signals, optical signals, and electromagnetic waves. The transitory computer-readable media can supply the programs to the computer via a wired communication path such as an electric wire and an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for explaining illustrative example embodiments are not necessarily mandatory, and some features or steps may be omitted. The order of the steps described in any of the drawings may be changed as appropriate.

Some or all of the above-described example embodiments may be described as the following Supplementary Notes, but are not limited to the following Supplementary Notes.

### Supplementary Note 1

A method for searching ledgers recorded in a database based on a description in a document, the method including
calculating degrees of importance of the ledgers with respect to the description by determining the type of each ledger and determining a category of a query that employs the description,
searching the ledgers using the query by searching for the description from among sentences written in the ledgers,
calculating degrees of similarity between the description employed in the query and the sentences written in the searched ledgers, and
determining a display order of the ledgers based on the degrees of importance of the ledgers and the degrees of similarity between the description and the sentences written in the ledgers.

### Supplementary Note 2

The method for searching ledgers according to Supplementary Note 1, in which the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

### Supplementary Note 3

The method for searching ledgers according to Supplementary Note 1, in which the determining the category of the query is performed by extracting a named entity in the query or extracting the named entity that has been modified using a similarity in the query and classifying the query for each named entity or each named entity that has been modified.

### Supplementary Note 4

The method for searching ledgers according to Supplementary Note 1, in which the degrees of similarity between the description and the sentences written in the ledgers are performed by calculating distances by vectorizing the description and the sentences written in the ledgers or using clustering.

### Supplementary Note 5

A system for searching ledgers recorded in a database based on a description in a document, the system including
a means for calculating degrees of importance of ledgers that calculates degrees of importance of the ledgers with respect to the description by determining the type of each ledger and determining a category of a query that employs the description,
a means for searching that searches the ledgers using the query by searching for the description from among sentences written in the ledgers,
a means for calculating degrees of similarity between a description and sentences written in ledgers that calculates degrees of similarity between the description employed in the query and the sentences written in the searched ledgers, and
a means for determining a display order of ledgers that determines a display order of the ledgers based on the degrees of importance of the ledgers and the degrees of similarity between the description and the sentences written in the ledgers.

### Supplementary Note 6

The system for searching ledgers according to Supplementary Note 5, in which the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

### Supplementary Note 7

The system for searching ledgers according to Supplementary Note 5, in which the determining the category of the query is performed by extracting a named entity in the query or extracting the named entity that has been modified using a similarity in the query and classifying the query for each named entity or each named entity that has been modified.

### Supplementary Note 8

The system for searching ledgers according to Supplementary Note 5, in which the degrees of similarity between the description and the sentences written in the ledgers are performed by calculating distances by vectorizing the description and the sentences written in the ledgers or using clustering.

### Supplementary Note 9

An information processing device for searching ledgers recorded in a database based on a description in a document, the information processing device including
a means for calculating degrees of importance of ledgers that calculates degrees of importance of the ledgers with respect to the description by determining the type of each ledger and determining a category of a query that employs the description,
a means for searching that searches the ledgers using the query by searching for the description from among sentences written in the ledgers,
a means for calculating degrees of similarity between a description and sentences written in ledgers that calculates degrees of similarity between the description employed in the query and the sentences written in the searched ledgers, and
a means for determining a display order of ledgers that determines a display order of the ledgers based on the degrees of importance of the ledgers and the degrees of similarity between the description and the sentences written in the ledgers.

### Supplementary Note 10

The information processing device according to Supplementary Note 9, in which the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

### Supplementary Note 11

The information processing device according to Supplementary Note 9, in which the determining the category of the query is performed by extracting a named entity in the query or extracting the named entity in the named entity that has been modified using a similarity in the query and classifying the query for each named entity or each named entity that has been modified.

### Supplementary Note 12

The information processing device according to Supplementary Note 9, in which the degrees of similarity between the description and the sentences written in the ledgers are performed by calculating distances by vectorizing the description and the sentences written in the ledgers or using clustering.

Some or all of the elements (for example, configurations and functions) described in Supplementary Notes 2 to 4 dependent on Supplementary Note 1 {e.g. method} can also be dependent on Supplementary Notes 5 {e.g. system} and 9 {e.g. information processing device} by the same dependency relationship as Supplementary Notes 2 to 4. Some or all of the elements described in any Supplementary Note may be applied to various types of hardware components, software components, recording means for recording software components, systems, and methods.

This application is based upon and claims the benefit of priority from Japanese patent application No. 2023-14930, filed on Feb. 2, 2023, the disclosure of which is incorporated herein in its entirety by reference.

### REFERENCE SIGNS LIST

400 system for searching ledgers
401 information processing device
402 unit for calculating degrees of importance of ledgers
403 unit for searching
404 unit for calculating degrees of similarity between description and sentences written in ledgers
405 unit for determining display order of ledgers
406 database
407 ledger

What is claimed is:

1. A method for searching ledgers recorded in a database based on a description in a document, the method comprising:
calculating degrees of importance of the ledgers with respect to the description by determining the type of each ledger and determining a category of a query that employs the description;
searching the ledgers using the query by searching for the description from among sentences written in the ledgers;
calculating degrees of similarity between the description employed in the query and the sentences written in the searched ledgers; and
determining a display order of the ledgers based on the degrees of importance of the ledgers and the degrees of similarity between the description and the sentences written in the ledgers.

2. The method for searching ledgers according to claim 1, wherein the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

3. The method for searching ledgers according to claim 1, wherein the determining the category of the query is performed by extracting a named entity in the query or extracting the named entity that has been modified using a similarity in the query and classifying the query for each named entity or each named entity that has been modified.

4. The method for searching ledgers according to claim 1, wherein the degrees of similarity between the description and the sentences written in the ledgers are performed by calculating distances by vectorizing the description and the sentences written in the ledgers or using clustering.

5. A system for searching ledgers recorded in a database based on a description in a document, the system comprising:
an unit for calculating degrees of importance of ledgers configured to calculate degrees of importance of the ledgers with respect to the description by determining the type of each ledger and determining a category of a query that employs the description;
an unit for searching configured to search the ledgers using the query by searching for the description from among sentences written in the ledgers;
an unit for calculating degrees of similarity between a description and sentences written in ledgers configured to calculate degrees of similarity between the description employed in the query and the sentences written in the searched ledgers; and
an unit for determining a display order of ledgers configured to determine a display order of the ledgers based on the degrees of importance of the ledgers and the degrees of similarity between the description and the sentences written in the ledgers.

6. The system for searching ledgers according to claim 5, wherein the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

7. The system for searching ledgers according to claim 5, wherein the determining the category of the query is performed by extracting a named entity in the query or extracting the named entity that has been modified using a similarity in the query and classifying the query for each named entity or each named entity that has been modified.

8. The system for searching ledgers according to claim 5, wherein the degrees of similarity between the description and the sentences written in the ledgers are performed by calculating distances by vectorizing the description and the sentences written in the ledgers or using clustering.

9. An information processing device for searching ledgers recorded in a database based on a description in a document, the information processing device comprising:
an unit for calculating degrees of importance of ledgers configured to calculate degrees of importance of the ledgers with respect to the description by determining the type of each ledger and determining a category of a query that employs the description;
an unit for searching configured to search the ledgers using the query by searching for the description from among sentences written in the ledgers;
an unit for calculating degrees of similarity between a description and sentences written in ledgers configured to calculate degrees of similarity between the description employed in the query and the sentences written in the searched ledgers; and
an unit for determining a display order of ledgers configured to determine a display order of the ledgers based on the degrees of importance of the ledgers and the degrees of similarity between the description and the sentences written in the ledgers.

10. The information processing device according to claim 9, wherein the determining the type of each ledger is performed using any one or a combination of determining the type of each ledger by extracting a document title by named entity extraction, determining the type of each ledger by using a tag embedded in the ledgers, determining the type of each ledger based on the sentences written in the ledgers by a classifier that has been subjected to machine learning, or determining the type of each ledger based on layouts of the ledgers by a layout analyzer that has been subjected to machine learning.

11. The information processing device according to claim 9, wherein the determining the category of the query is performed by extracting a named entity in the query or extracting the named entity in the named entity that has been modified using a similarity in the query and classifying the query for each named entity or each named entity that has been modified.

12. The information processing device according to claim 9, wherein the degrees of similarity between the description and the sentences written in the ledgers are performed by calculating distances by vectorizing the description and the sentences written in the ledgers or using clustering.

13. A non-transitory computer readable medium storing a program causing a processor to perform the method according to claim 1.
